(19) United States
(12) Patent Application Publication
(10) Pub. No.: US 2026/0370475 A1
(43) Pub. Date: Nov. 19, 2026

(54) CLOUD-AGNOSTIC IDENTITY TOKEN PLATFORM

(71) Applicant: State Farm Mutual Automobile Insurance Company, Bloomington, IL (US)

(72) Inventor: Samuel Seekamp, McKinney, TX (US)

(21) Appl. No.: 19/566,751

(22) Filed: Mar. 13, 2026

Related U.S. Application Data
(63) Continuation-in-part of application No. 19/206,989, filed on May 13, 2025.

(51) Int. Cl. H04L 9/32

(52) U.S. Cl. CPC H04L 9/3213; H04L 9/3247

(57) ABSTRACT

A token platform instance is temporarily instantiated to generate a cloud-agnostic identity token for a first function executing in a first cloud computing environment. The token platform instance causes a separate token signing service to sign the identity token, stores public key material associated with the signed identity token in a repository, and provides the signed identity token to the first function before the token platform instance terminates. The first function may provide the signed identity token to a second function executing in a second cloud computing environment. The second function may verify the identity of the first function by retrieving the public key material from the repository, and using the public key material to verify the signature of the identity token.

### RELATED APPLICATIONS

This U.S. patent application is a continuation-in-part of, and claims priority to, U.S. patent application Ser. No. 19/206,989, filed on May 13, 2025, which is incorporated herein by reference in its entirety.

### TECHNICAL FIELD

The present disclosure relates to computer-executable functions, and more particularly, to verification of identities of computer-executable functions that execute in different cloud computing environments.

### BACKGROUND

Functions, such as applications, services, workloads, or other executable elements, may execute in cloud computing environments. Functions may interact with other functions. For instance, one function may use a service provided by a different function.

Identity Access Management (IAM) systems may provide techniques that allow functions to verify identities of other functions, for instance before the functions are allowed to interact. As an example, if two functions execute in the same cloud computing environment, a native IAM system in that cloud computing environment may provide the functions with identity credentials that may be understood and/or used by other functions in the same cloud computing environment.

However, if a first function in a first cloud computing environment interacts with a second function in a different second cloud computing environment, the second function in the second cloud computing environment may be unable to natively use or understand native identity credentials of the first function that are used within the first cloud computing environment. It may accordingly be difficult to verify identities of functions within different cloud computing environments, secure communications between such functions, manage permissions associated with such functions, and ensure compliance associated with such functions.

Other techniques, aside from the use of native identity credentials that may only be understood within one cloud computing environment, may accordingly be used to establish identities and trust between functions in different cloud computing environments. In some examples, functions in different cloud computing environments may establish identities and trust by sharing and/or using static secrets, such as usernames and passwords, Application Programming Interface (API) keys, randomly-generated passwords, and/or other data. However, such static secrets may be difficult to manage, store, and/or rotate, and may be at risk of being stolen.

In other examples, functions may be associated with cloud-agnostic identity credentials, instead of or in addition to cloud-native identity credentials, and may use the cloud-agnostic identity credentials to establish identities and trust with functions in other cloud computing environments. For instance, Secure Production Identity Framework for Everyone (SPIFFE) standards may allow functions to be associated with corresponding SPIFFE tokens that may be used to identify the functions in heterogeneous environments, such as in different cloud computing environments.

In some examples, SPIFFE tokens may be used within a SPIFFE Runtime Environment (SPIRE) system. In a SPIRE system, a SPIRE server may be set up to generate and manage SPIFFE tokens associated with respective functions. For instance, the SPIRE server may generate SPIFFE tokens for functions, and may maintain a registry of the SPIFFE tokens it has generated for the functions. In the SPIRE system, executable SPIRE agents may also be installed, and execute, on computing nodes that execute functions. The SPIRE agents may store SPIFFE tokens generated by the SPIRE server for respective functions, and may provide the SPIFFE tokens to SPIRE agents associated with other functions as part of identity verification processes.

For instance, during an identity verification process, a first SPIRE agent executing in association with a first function may provide a SPIFFE token for the first function to a second SPIRE agent executing in association with a second function, such as a second function executing in a different computing environment. The second SPIRE agent may provide the SPIFFE token for the first function to the SPIRE server, so that the SPIRE server may verify that the SPIFFE token for the first function is valid.

However, it may be difficult and/or resource-intensive to use cloud-agnostic identity credentials in a SPIRE system. For instance, in a SPIRE system, a SPIRE server may need to be in continuous operation to generate, manage, and authenticate SPIFFE tokens associated with various functions. Such a continuously-operating SPIRE server may consume significant amounts of memory, computing cycles, and/or other computing resources. Moreover, the SPIRE server may sign SPIFFE tokens itself using public keys and private keys, and/or otherwise have access to both public keys and private keys associated with signed SPIFFE tokens. Because the SPIRE server may be in continuous operation and may have access to both public keys and private keys, there may be security risks of the private keys being exposed outside the SPIRE server.

Additionally, in a SPIRE system, executable SPIRE agents may need to be installed on computing nodes that also execute functions, so that the separately-executing SPIRE agents may manage SPIFFE tokens that identify the functions. However, such SPIRE agents that execute separately from the functions may consume significant amounts of memory, computing cycles, and/or other computing resources.

Such SPIRE agents may also be difficult or impractical to use in association with temporary functions, such as temporary serverless functions that are spun up to execute for a relatively brief period of time, potentially only seconds or minutes long, within a cloud computing environment before being terminated. When such a temporary function is instantiated, the cloud computing environment may temporarily allocate physical and/or virtual computing resources to the temporary function, and may de-allocate and/or re-use those resources after the temporary function is terminated. Because such resources may only be allocated to a temporary function for a brief period of time, it may not be possible or practical to also install a separate SPIRE agent on those allocated resources in order to have the separate SPIRE agent execute to manage a SPIFFE token for the temporary function that may only be in existence for the brief period of time.

The example systems and methods described herein may be directed toward mitigating or overcoming one or more of the deficiencies described above.

### SUMMARY

Described herein are systems and methods for an Identity Access Management (IAM) system that may verify identities of functions executing in different cloud computing environments or other platforms. A token platform instance may be temporarily instantiated, by a gateway, to generate a cloud-agnostic identity token for a first function that executes in a first cloud computing environment. The cloud-agnostic identity token may, for example, be a SPIFFE token that identifies the first function. The token platform instance may cause a separate token signing service to sign the identity token, and may receive public key material associated with the signed identity token from the token signing service. The token platform instance may store the public key material associated with the signed identity token in a repository, and provide the signed identity token to the first function. The temporary token platform instance may then terminate. After the first function receives the identity token, the first function may provide the identity token to another function, such as a second function executing in a second cloud computing environment. Although the second function executes in a different cloud computing environment than the first function, the second function may verify the identity of the first function by retrieving the public key material from the repository, and by using the public key material to verify the signature of the identity token.

In some aspects described herein, a computer-implemented method for identity access management includes receiving, by a gateway, a cloud-native credential that indicates an identity of a function executing within a cloud computing environment. The cloud-native credential is received in association with a request for an identity token, associated with the function, that includes a cloud-agnostic credential. The computer-implemented method also includes determining, by the gateway, to instantiate a token platform instance based at least in part on validating the cloud-native credential. The computer-implemented method also includes instantiating, by the gateway, the token platform instance. The token platform instance includes a temporary computer-executable element configured to generate the identity token, cause a token signing service to sign the identity token with a digital signature, receive, from the token signing service, public key material associated with the digital signature, and store the public key material in a public key repository. The computer-implemented method also includes receiving, by the gateway, the identity token from the token platform instance. The computer-implemented method also includes providing, by the gateway, the identity token to the function or a credential manager associated with the function.

In some aspects described herein, one or more non-transitory computer-readable media store computer-executable instructions associated with an identity access management system. The computer-executable instructions, when executed by one or more processors of a computing system, cause the computing system to receive, by a gateway, a cloud-native credential that indicates an identity of a function executing within a cloud computing environment. The cloud-native credential is received in association with a request for an identity token, associated with the function, that includes a cloud-agnostic credential. The computer-executable instructions also cause the computing system to determine, by the gateway, to instantiate a token platform instance based at least in part on validating the cloud-native credential. The computer-executable instructions also cause the computing system to instantiate, by the gateway, the token platform instance. The token platform instance includes a temporary computer-executable element configured to generate the identity token, cause a token signing service to sign the identity token with a digital signature, receive, from the token signing service, public key material associated with the digital signature, and store the public key material in a public key repository. The computer-executable instructions also cause the computing system to receive the identity token from the token platform instance. The computer-executable instructions also cause the computing system to provide, by the gateway, the identity token to the function or a credential manager associated with the function.

In some aspects described herein, a computing system includes one or more processors, and memory storing computer-executable instructions associated with a gateway of an identity access management system. The computer-executable instructions, when executed by the one or more processors, cause the gateway to receive a cloud-native credential that indicates an identity of a function executing within a cloud computing environment. The cloud-native credential is received in association with a request for an identity token, associated with the function, that includes a cloud-agnostic credential. The computer-executable instructions cause the gateway to determine to instantiate a token platform instance based at least in part on validating the cloud-native credential. The computer-executable instructions cause the gateway to instantiate the token platform instance. The token platform instance includes a temporary computer-executable element configured to generate the identity token, cause a token signing service to sign the identity token with a digital signature, receive, from the token signing service, public key material associated with the digital signature, and store the public key material in a public key repository. The computer-executable instructions cause the gateway to receive the identity token from the token platform instance. The computer-executable instructions cause the gateway to provide the identity token to the function or a credential manager associated with the function.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows a first example of a system in which a token platform instance may provide a first function with an identity token configured to verify the identity of the first function.

FIG. 2 shows a second example of the system, in which a gateway may determine whether to cause the token platform instance to provide the first function with an identity token.

FIG. 3 shows a third example of the system, in which a credential manager associated with the first function may interact with the gateway and/or a second function.

FIG. 4 shows a flowchart illustrating an example method for generating the identity token for the first function via the token platform instance.

FIG. 5 shows a flowchart illustrating an example method for instantiating the token platform instance.

FIG. 6 shows a flowchart illustrating an example method for obtaining and using an identity token, associated with the first function, generated by the token platform instance.

FIG. 7 shows a flowchart illustrating an example method for a second function to verify the identity of the first function based on the identity token generated by the token platform instance.

FIG. 8 shows an example system architecture for a computing system that may execute the token platform instance and/or other elements described herein.

### DETAILED DESCRIPTION

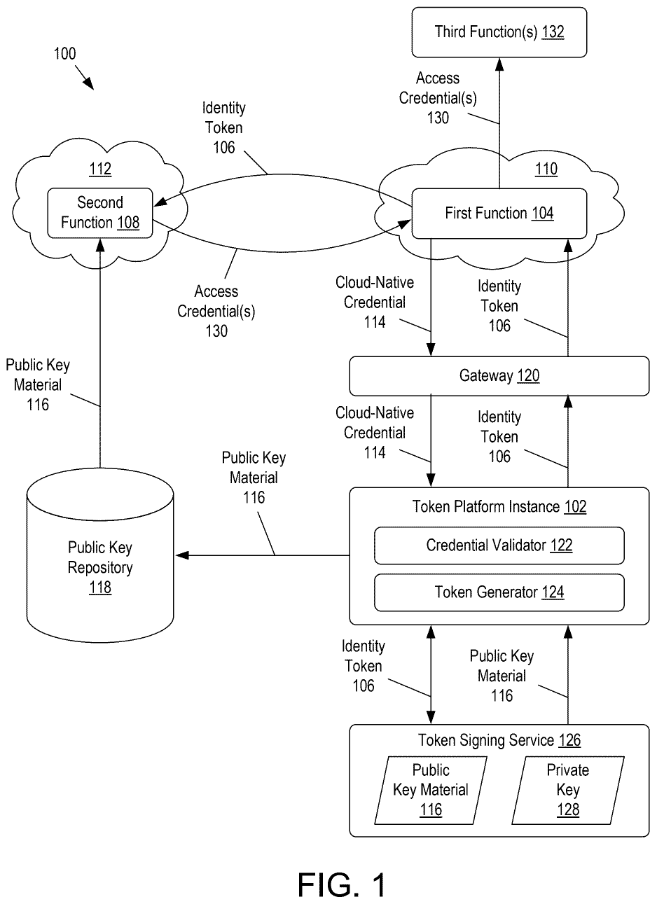

FIG. 1 shows a first example 100 of a system in which a token platform instance 102 may provide a first function 104 with an identity token 106 configured to verify the identity of the first function 104 to a second function 108 in a different cloud computing environment. The first function 104 may provide the identity token 106 to the separate second function 108, such that the second function 108 may use the identity token 106 to verify the identity of the first function 104. Accordingly, the token platform instance 102 may be, or may be used in, an IAM system that allows the first function 104 to verify its identity and establish trust with the second function 108.

The first function 104 may be a computer-executable element, such as an application, service, microservice, workload, or other computer-executable element. The second function 108 may similarly be a computer-executable element, such as an application, service, microservice, workload, or other computer-executable element. The first function 104 may be configured to access, use, or communicate with the second function 108, and/or the second function 108 may be configured to access, use, or communicate with the first function 104.

The first function 104 and the second function 108 may execute in different cloud computing environments, such that the first function 104 executes in a first cloud computing environment 110 and the second function 108 executes in a different second cloud computing environment 112. Cloud computing environments may include Amazon Web Services (AWS), Google Cloud, Microsoft Azure, and/or other cloud computing environments that may be provided and/or operated by different entities.

As a non-limiting example, the first cloud computing environment 110 may be AWS, and the first function 104 may be an AWS Lambda function. In this example, the second cloud computing environment 112 may be Google Cloud, Microsoft Azure, or another cloud computing environment different from AWS, and the second function 108 may accordingly be a Google Cloud function, a Microsoft Azure function, or a function that executes in the second cloud computing environment 112. In other examples, the first cloud computing environment 110 may be Google Cloud, Microsoft Azure, or another cloud computing environment, and the second cloud computing environment 112 may be AWS or another cloud computing environment that is different from the first cloud computing environment 110 that executes the first function 104.

The first function 104 may be a serverless compute service that may be spun up or otherwise created to execute in the first cloud computing environment 110, for instance via a server, a container, a virtual machine, and/or other physical and/or virtual computing resources provided by the first cloud computing environment 110. The first function 104 may be a temporary serverless service that may be created and executed for a relatively short period of time, and then may be terminated. As an example, the first function 104 may be a containerized application that may be temporarily instantiated and/or executed via a framework or platform, such as Kubernetes, within the first cloud computing environment 110. Accordingly, in some examples the first function 104 may exist for a relatively short period of time, such as seconds, minutes, or hours. In these examples, the first function 104 may be a temporary or one-time use instance of a service or application that may be created and used on demand, for instance based on a predefined image or template, and is not continuously or persistently executed in the first cloud computing environment 110. However, in other examples, the first function 104 may be continuously or persistently executed in the first cloud computing environment 110.

The second function 108 may similarly be a serverless compute service, or other type of executable element, that may temporarily or persistently execute in the second cloud computing environment 112. For instance, the second function 108 may execute via a server, a container, a virtual machine, and/or other physical and/or virtual computing resources provided by the second cloud computing environment 112.

The second function 108 in the second cloud computing environment 112 may be configured to verify the identity of the first function 104 in the first cloud computing environment 110, in some examples before other interactions between the second function 108 and the first function 104 may proceed. For instance, the second function 108 may verify the identity of the first function 104 in order to determine whether the second function 108 is authorized to interact with the first function 104, to determine what types of services the second function 108 is permitted to provide to the first function 104, and/or to determine other types of information about the first function 104 and/or interactions between the first function 104 and the second function 108.

As a non-limiting example, the first function 104 may be configured to perform operations in association with user accounts, and the second function 108 may be a directory of valid user accounts associated with an organization. For instance, the second function 108 may be a Microsoft® Azure Entra directory service, or other type of directory service. When the first function 104 is performing operations in association with a particular user account, the first function 104 may be configured to interact with the second function 108 to verify that the particular user account is a valid user account associated with the organization, and/or to retrieve or access information about the particular user account from the second function 108. However, before the second function 108 may interact with the first function 104 in association with the particular user account, the second function 108 may be configured to verify the identity of the first function 104. For instance, the second function 108 may verify the identity of the first function 104 to confirm that the first function 104 is authorized to receive information from the second function 108 about the particular user account.

The first function 104 may be associated with a cloud-native credential 114 that may be used to verify the identity of the first function 104. The cloud-native credential 114 may include a token, certificate, identifier, and/or other types of data that may indicate or verify the identity of the first function 104 within the first cloud computing environment 110. As an example, if the first cloud computing environment 110 is an AWS cloud computing environment, the cloud-native credential 114 may be an AWS Security Token Service (STS) token. As another example, if the first function 104 executes within the first cloud computing environment 110 via Kubernetes and a Red Hat OpenShift Service on AWS (ROSA), the cloud-native credential 114 may be a ROSA JSON web token credential.

The cloud-native credential 114 may be provided by the first cloud computing environment 110, such that other functions and elements that are also within the first cloud computing environment 110 may use the cloud-native credential 114 to verify the identity of the first function 104. However, because the second function 108 executes in the second cloud computing environment 112, and not in the first cloud computing environment 110 where the first function 104 executes, the second function 108 may be unable to use or understand the cloud-native credential 114 for the first function 104 that is natively used within the first cloud computing environment 110.

However, instead of using the cloud-native credential 114, the second function 108 may use the identity token 106 to verify the identity of the first function 104 as described herein. For instance, the second function 108 in the second cloud computing environment 112 may use the identity token 106 to verify the identity of the first function 104 in the first cloud computing environment 110, before the first function 104 can use the second function 108 and/or before the second function 108 can use the first function 104.

The identity token 106 may accordingly be a cloud-agnostic identity credential that may verify the identity of the first function 104 to the second function 108, even though the second function 108 executes in a different cloud computing environment than the first function 104. The identity token 106 may, for instance, be a Secure Production Identity Framework for Everyone (SPIFFE) token, or other type of cloud-agnostic identity credential. Although the identity token 106 is described herein as being used by the first function 104 to verify the identity of the first function 104 with the second function 108 executing in the second cloud computing environment 112, the first function 104 may also or alternatively use the identity token 106 to verify the identity of the first function 104 with one or more functions in the first cloud computing environment 110, with one or more functions in the second cloud computing environment 112, and/or with one or more functions in other cloud computing environments, on-premise computing environments, and/or other computing platforms or environments.

As an example, open-source SPIFFE standards may define a framework for identifying software elements in heterogeneous environments, such as different cloud computing environments. Accordingly, the identity token 106 may be a SPIFFE token that is configured to verify the identity of the first function 104 to other elements in heterogeneous environments, such as the second function 108 executing in the second cloud computing environment 112 and/or other elements executing via any cloud computing environment or other computing environment or platform. Such a SPIFFE token associated with the first function 104 may, for instance, be a SPIFFE Verifiable Identity Document (SVID) that encodes or otherwise contains a SPIFFE identifier (ID) of the first function 104. Accordingly, the SPIFFE token may be a cryptographically-verifiable document, such as an X.509 certificate, a JavaScript Object Notation (JSON) Web Token (JWT), or other data element, that encodes or includes the SPIFFE ID of the first function 104.

The identity token 106, such as a SPIFFE token, may be a JSON data element that indicates values of one or more attributes. Such attributes of the JSON data element may include, for example, an indicator of the format of the identity token 106, an identifier of the first function 104, an identifier of the token platform instance 102 that generated the identity token 106, a generation time indicating when the identity token 106 was generated, an expiration time indicating when the identity token 106 expires, and/or other information about the first function 104, the token platform instance 102, the identity token 106, and/or other elements described herein.

In some examples, the identity token 106 may expire after a period of time. For example, the identity token 106 may be coded with an expiration time, such as one hour or any other period of time, after the generation time at which the identity token 106 was generated by the token platform instance 102. Accordingly, the identity token 106 may be considered to be expired and invalid after that expiration time, or after a corresponding period of time has elapsed following generation of the identity token 106.

The identity token 106 may be signed in association with corresponding public key material 116. The public key material 116 may be a public key, a set of one or more certificates, or other data. As an example, if the identity token 106 is an X.509-SVID, the public key material 116 may be a set of certificate authority (CA) root certificates that corresponds to the X.509-SVID. As another example, if the identity token 106 is a JWT-SVID, the public key material 116 may be a raw public key that corresponds to the JWT-SVID. The second function 108 may use the public key material 116 that corresponds with the identity token 106 to validate the identity token 106 and verify the identity of the first function 104.

As described herein, the token platform instance 102 may generate the identity token 106 for the first function 104. The token platform instance 102 may provide the identity token 106 to the first function 104, such that the first function 104 may provide the identity token 106 to the second function 108. The token platform instance 102 may also provide the public key material 116 that corresponds to the identity token 106 to a public key repository 118. When the second function 108 receives the identity token 106 from the first function 104, the second function 108 may obtain the corresponding public key material 116 from the public key repository 118, and use the public key material 116 to validate the identity token 106 in order to verify the identity of the first function 104.

The token platform instance 102 may be instantiated as a temporary instance of an application, service, microservice, workload, or other computer-executable element within a computing environment. The token platform instance 102 may be a temporary element that may be instantiated and used on-demand, rather than an always-on or persistent element. As a non-limiting example, the token platform instance 102 may be an AWS Lambda function.

In some examples, the token platform instance 102 may be a serverless function that temporarily executes in the first cloud computing environment 110. For example, although the first function 104 may execute in the first cloud computing environment 110, the token platform instance 102 may be separately instantiated in the first cloud computing environment 110. In other examples, the token platform instance 102 may be a temporary instance that executes in the second cloud computing environment 112, in another cloud computing environment, or on a server or other computing system in an on-premises computing environment or another computing environment. Accordingly, the token platform instance 102 may be hosted by, and/or executed via, a server, a container, a virtual machine, and/or other physical and/or virtual computing resources provided by a cloud computing environment, such as the first cloud computing environment 110, the second cloud computing environment 112, or another cloud computing environment.

The token platform instance 102 may be associated with a gateway 120. For instance, the gateway 120 may be an API gateway. The gateway 120 may be hosted on, and/or executed via, a computing environment that executes the token platform instance 102 and/or the first function 104, or may execute in a different computing environment. For example, the gateway 120 may be hosted by, and/or executed via, a server, a container, a virtual machine, and/or other physical and/or virtual computing resources provided by a cloud computing environment, such as the first cloud computing environment 110, the second cloud computing environment 112, or another cloud computing environment.

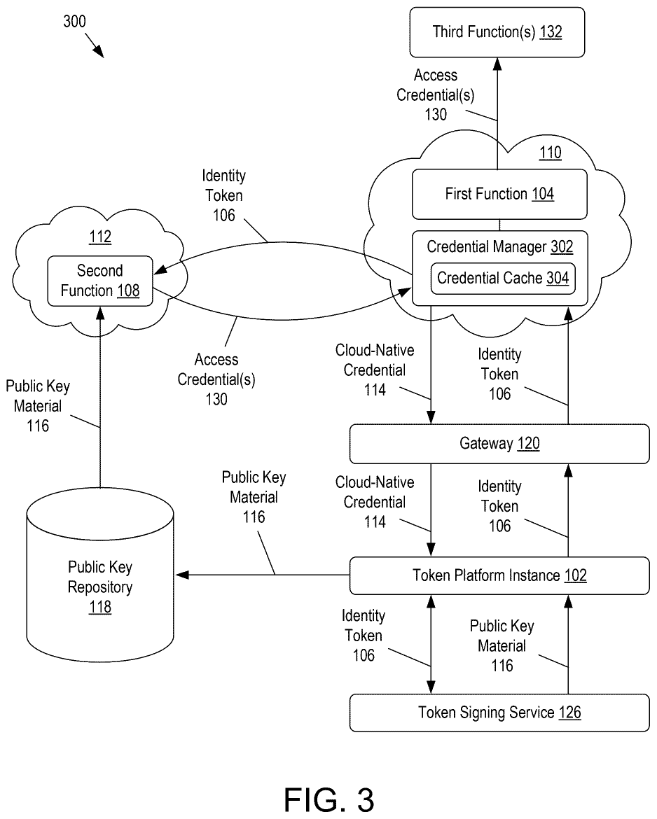

The gateway 120 may be associated with an API, to which a request for the identity token 106 associated with the first function 104 may be submitted. The request may include the cloud-native credential 114, or may be sent in addition to the cloud-native credential 114. In some examples, as shown in FIG. 1, the first function 104 may use the API to send the cloud-native credential 114 associated with the first function 104 to the gateway 120 as part of, or along with, a request for an identity token 106. In other examples, a credential manager or other element executing in the first cloud computing environment 110 alongside the first function 104, or in conjunction with the first function 104, may send the cloud-native credential 114 associated with the first function 104 to the gateway 120 as part of, or along with, a request for an identity token 106, as discussed further below with respect to FIG. 3.

Although the token platform instance 102 described herein may be a temporary element that executes for a relatively short period of time, the gateway 120 may be a continuously-executing element that may receive the cloud-native credential 114 from the first function 104 or a corresponding element at any time, and may cause the token platform instance 102 to be temporarily executed in response to receipt of the cloud-native credential 114. Accordingly, in response to receipt of the cloud-native credential 114 associated with the first function 104 and/or a corresponding request for an identity token 106, the gateway 120 may cause the token platform instance 102 to be instantiated and/or to begin executing.

For example, when the gateway 120 receives the cloud-native credential 114 from the first function 104, the gateway 120 may request that the token platform instance 102 be temporarily instantiated. Accordingly, in response to the request from the gateway 120, the computing environment that executes the token platform instance 102 may use an image or template to spin up or instantiate the token platform instance 102. The gateway 120 may also pass the cloud-native credential 114 associated with the first function 104 to the token platform instance 102.

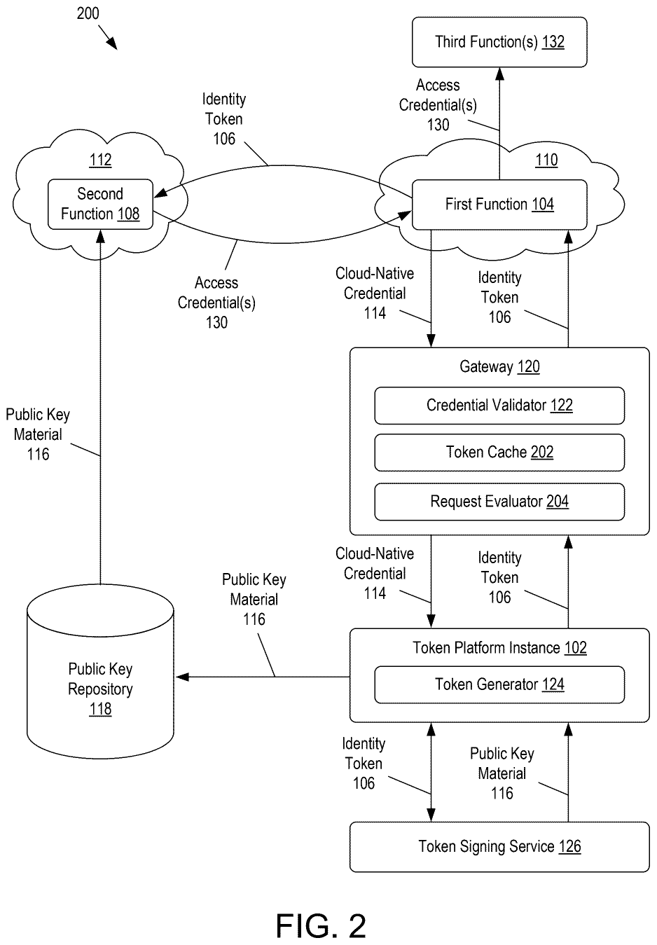

In some examples, the gateway 120 may instantiate the token platform instance 102 substantially immediately upon the gateway 120 receiving the cloud-native credential 114 and/or a corresponding request for an identity token 106. In other examples, the gateway 120 may be configured to evaluate a received cloud-native credential 114 and/or a corresponding request for an identity token 106 in order to determine whether to instantiate the token platform instance 102, as discussed further below with respect to FIG. 2.

In some examples, the token platform instance 102 may be coded using a compiled programming language, such as Golang, instead of an interpreted programming language such as JavaScript or Python. Accordingly, source code for the token platform instance 102 may be compiled into machine code and/or an optimized executable file that may be executed substantially immediately when invoked, rather than the source code being interpreted line-by-line during runtime via an interpretation element. As a non-limiting example, the token platform instance 102 being coded in a compiled programming language may allow the token platform instance 102 to be instantiated and to perform operations as described herein in less than 50 milliseconds. However, in other examples, the token platform instance 102 may be coded using an interpreted programming language.

A credential validator 122 associated with the token platform instance 102 may be configured to validate the cloud-native credential 114 associated with the first function 104. The credential validator 122 may be configured to validate one or more types of cloud-native credentials. For example, the credential validator 122 may be configured to validate AWS STS tokens, ROSA credentials, and/or other types of cloud-native credentials.

In some examples, the credential validator 122 may be coded to natively understand and/or interpret one or more types of cloud-native credentials. For instance, if the credential validator 122 executes in the first cloud computing environment 110, the credential validator 122 may be configured to natively understand one or more types of cloud-native credentials that are used within the first cloud computing environment 110, such that the credential validator 122 may accordingly validate the cloud-native credential 114 of the first function 104.

In other examples, the credential validator 122 may be configured to communicate with one or more separate IAM systems that are configured to validate respective types of cloud-native credentials. As an example, the credential validator 122 may execute in the first cloud computing environment 110, and the credential validator 122 may be configured to access and use a separate IAM system of the first cloud computing environment 110 to validate the cloud-native credential 114 of the first function 104. As another example, the credential validator 122 may execute in the second cloud computing environment 112 or a different computing environment, and the credential validator 122 may be configured to access and use an identity system of the first cloud computing environment 110 to validate the cloud-native credential 114 of the first function 104.

In some examples, the credential validator 122 may be an element of the token platform instance 102, as shown in FIG. 1. For example, after the token platform instance 102 has been instantiated by the gateway 120, the token platform instance 102 may use the credential validator 122 to validate the cloud-native credential 114 provided by the first function 104 via the gateway 120. In other examples, the credential validator 122 may be an element of the gateway 120, as discussed further below with respect to FIG. 2. Accordingly, as discussed with respect to FIG. 2, in such examples the gateway 120 may use the credential validator 122 to validate the cloud-native credential 114, and the gateway 120 may be configured to cause the token platform instance 102 to be instantiated in response to a successful validation of the cloud-native credential 114 by the gateway 120.

The token platform instance 102 may have a token generator 124. The token generator 124 may be configured to generate the identity token 106, such as a SPIFFE token, associated with the first function 104. In some examples, the token platform instance 102 may use the token generator 124 to generate the identity token 106 based on the cloud-native credential 114 being validated by the credential validator 122. For example, if the credential validator 122 determines that the cloud-native credential 114 associated with the first function 104 is valid, the token generator 124 may generate the identity token 106 associated with the first function 104.

The token platform instance 102 may provide the identity token 106, generated by the token generator 124, to a token signing service 126 that is separate from the token platform instance 102. In some examples, the token signing service 126 may execute in the first cloud computing environment 110, in the second cloud computing environment 112, or in a different computing environment. For example, the token signing service 126 may be hosted by, and/or executed via, a server, a container, a virtual machine, and/or other physical and/or virtual computing resources provided by a cloud computing environment, such as the first cloud computing environment 110, the second cloud computing environment 112, or another cloud computing environment. However, the token signing service 126 may be an external service, application, or function that executes independently from the token platform instance 102, the gateway 120, the first function 104, the second function 108, and/or other elements described herein.

As a non-limiting example, the token signing service 126 may be an AWS Key Management Service (KMS) that is provided by, and/or executes in, an AWS cloud computing environment. In some examples, the first function 104 and/or the token platform instance 102 may also execute in the AWS cloud computing environment. However, in these examples the AWS KMS may execute independently from the first function 104 and the token platform instance 102 within the AWS cloud computing environment, such that the AWS KMS is not a component of the token platform instance 102 or the first function 104.

The token signing service 126 may be configured to cryptographically sign the identity token 106 that has been generated by the token platform instance 102. For example, the token signing service 126 may generate an OpenID Connect (OIDC) signature or other type of digital signature, and use that signature to cryptographically sign the identity token 106. The token signing service 126 may generate and/or use a private key 128 and public key material 116 to digitally sign the identity token 106 via public-key cryptography. For example, the token signing service 126 may use the private key 128 to create a digital signature for the identity token 106, such that the digital signature for the identity token 106 may be verified with the corresponding public key material 116. As described above, the public key material 116 may be a public key, a set of one or more certificates, or other data.

When the token signing service 126 signs the identity token 106, the token signing service 126 may return the signed version of the identity token 106 to the token platform instance 102. The token signing service 126 may also provide the public key material 116 associated with the identity token 106 to the token platform instance 102. However, the token signing service 126 may keep the private key 128 associated with the identity token 106 as a secret, and not provide the private key 128 associated with the signed identity token 106 to the token platform instance 102. Accordingly, the token signing service 126 may not expose the private key 128 to the token platform instance 102.

The token platform instance 102 may store the public key material 116 associated with the identity token 106 in the public key repository 118. The public key repository 118 may be a database or other data repository that is separate from the token platform instance 102. The public key repository 118 may, for instance, be an AWS S3 bucket or other type of data repository or database that is separate from the token platform instance 102. As described herein, the second function 108 and/or other elements may access the public key material 116 associated with the identity token 106 from the public key repository 118, instead of from the token platform instance 102 or other elements described herein.

For example, the token platform instance 102 may publish the public key material 116 associated with the identity token 106 to the public key repository 118, or otherwise transfer the public key material 116 to be stored in the public key repository 118. The public key material 116 may be published or stored in the public key repository 118 in association with a corresponding name, number, or other identifier of the first function 104 or the identity token 106, such that the second function 108 may later retrieve the public key material 116 from the public key repository 118 in association with the first function 104 and/or the identity token 106 of the first function 104.

In some examples, the public key repository 118 may be maintained in the first cloud computing environment 110, in the second cloud computing environment 112, or in a different computing environment. For instance, the public key repository 118 may be hosted by, and/or executed via, a server, a container, a virtual machine, and/or other physical and/or virtual computing resources provided by a cloud computing environment, such as the first cloud computing environment 110, the second cloud computing environment 112, or another cloud computing environment. The computing environment that maintains the public key repository 118 may be accessible via the Internet, such that the public key repository 118 may be accessed via the Internet. Accordingly, the public key repository 118 may be accessible to the second function 108 and/or other elements via the Internet as discussed herein.

However, the public key repository 118 may be maintained separately from the token platform instance 102, the gateway 120, the first function 104, the second function 108, the token signing service 126, and/or other elements described herein. Accordingly, although the token platform instance 102 may be a temporary element that may be instantiated and used for a relatively short period of time, the public key material 116 associated with the identity token 106 may be maintained persistently or for a longer period of time in the public key repository 118.

In addition to storing the public key material 116 associated with the identity token 106 in the public key repository 118, in some examples the token platform instance 102 may provide the identity token 106 to the first function 104. For instance, after the identity token 106 has been signed by the separate token signing service 126, the token platform instance 102 may provide the signed identity token 106 to the first function 104. In some examples, the token platform instance 102 may provide the identity token 106 to the first function 104 via the gateway 120, for instance via the API that the first function 104 used to provide the cloud-native credential 114 or a similar API. In other examples, the token platform instance 102 may provide the identity token 106 to a credential manager associated with the first function 104, as described further below with respect to FIG. 3.

After the token platform instance 102 has provided the identity token 106 to the first function 104 or an associated credential manager, and has stored the corresponding public key material 116 in the public key repository 118, the token platform instance 102 may terminate. As discussed above, the token platform instance 102 may be created by the gateway 120 as a temporary instance. Accordingly, the token platform instance 102 may execute temporarily to validate the cloud-native credential 114 associated with the first function 104, generate the identity token 106 associated with the first function 104, have the identity token 106 signed by the separate token signing service 126, store the public key material 116 used by the token signing service 126 to sign the identity token 106 in the public key repository 118, and/or provide the signed identity token 106 to the first function 104 or an associated credential manager. After performing such functions, the temporary token platform instance 102 may terminate, be destroyed, or otherwise cease functioning.

In some examples, when the first function 104 interacts with the second function 108, the first function 104 may provide the signed identity token 106 to the second function 108. In other examples, a credential manager associated with the first function 104 may provide the signed identity token 106 to the second function 108, as discussed below with respect to FIG. 3.

When the second function 108 receives the identity token 106, the second function 108 may retrieve the public key material 116 associated with the identity token 106 from the public key repository 118. The second function 108 may use the retrieved public key material 116 to verify the signature of the identity token 106 and in turn verify the identity of the first function 104.

After the second function 108 has verified the identity of the first function 104 using the identity token 106 and the public key material 116, subsequent interactions between the second function 108 and the first function 104 and/or an associated credential manager may be permitted to proceed. For example, the first function 104 may use services provided by the second function 108, the second function 108 may use services provided by the first function 104, and/or the second function 108 may provide data to a credential manager associated with the first function 104.

In some examples, the second function 108 may use the identity token 106 to verify the identity of the first function 104, and the second function 108 may then issue one or more access credentials 130 to the first function 104. An access credential 130 may be a JSON token or other data element or credential that is different from the identity token 106 and the cloud-native credential 114.

In some examples, an access credential 130 may be specific to the second function 108 and/or to interactions between the second function 108 and the first function 104. For instance, an access credential 130 may allow the first function 104 to access and use the second function 108, after the second function 108 has used the identity token 106 to verify the identity of the first function 104. Accordingly, the identity token 106 that identifies the first function 104 may effectively be exchanged for an access credential 130 specific to the second function 108, after the second function 108 has used the identity token 106 to verify the identity of the first function 104. In such examples, the first function 104 may use the access credential 130 in association with further interactions with the second function 108, instead of or in addition to the identity token 106. In other examples, the first function 104 and the second function 108 may perform authentication and/or identity verification operations in association with further interactions based on the identity token 106, such that the second function 108 may not issue a separate access credential 130 for the first function 104.

In other examples, if the second function 108 verifies the identity of the first function 104 based on the identity token 106 and the corresponding public key material 116 obtained from the public key repository 118, the second function 108 may provide the first function 104 or a corresponding credential manager with one or more access credentials 130 that the first function 104 may subsequently use to interact with one or more third functions 132. The third functions 132 may be computer-executable elements, such as applications, services, microservices, workloads, or other computer-executable elements. The third functions 132 may execute in the first cloud computing environment 110, the second cloud computing environment 112, one or more other cloud computing environments, on-premise computing environments, and/or other computing platforms or environments.

The third functions 132 may be configured to allow the first function 104 to interact with the third functions 132 if the first function 104 provides the third functions 132 with respective access credentials 130 obtained from the second function 108. As an example, the first function 104 may be an application that is designed to interact with numerous third functions 132. Each of the third functions 132 may be configured to authenticate or validate the first function 104 based on respective different access credentials 130 that are managed or provided by the second function 108, instead of based on the cloud-native credential 114 or the identity token 106. Accordingly, the first function 104 may exchange its cloud-native credential 114 for a corresponding cloud-agnostic identity token 106 via the token platform instance 102 as described herein, and the first function 104 may then provide the cloud-agnostic identity token 106 to the second function 108 to obtain one or more access credentials 130 that allow the first function 104 to respectively interact with one or more third functions 132.

Overall, the second function 108 may use the identity token 106 and the public key material 116 to verify the identity of the first function 104, even though the second function 108 executes in a different cloud computing environment than the first function 104 and may not otherwise be able to use or understand the cloud-native credential 114 associated with the first function 104. The second function 108 may use the public key material 116 retrieved from the public key repository 118 to verify the signature of the identity token 106, without the second function 108 interacting with the token platform instance 102. As discussed above, the token platform instance 102 may execute temporarily, and may have terminated by a time at which the second function 108 attempts to verify the identity of the first function 104 using the identity token 106 and the public key material 116.

Additionally, the private key 128 used by the token signing service 126 to sign the identity token 106 may be kept secret at the token signing service 126, such that the private key 128 is not exposed to the token platform instance 102 and is not published or accessible by the second function 108 or other elements described herein. Accordingly, security of the identity token 106 may be enhanced because the private key 128 used to sign the identity token 106 is not exposed to other elements outside of the token signing service 126.

In some examples, the identity token 106 and/or the public key material 116 associated with the first function 104 may be updated relatively frequently in association with key rotation operations, for instance every day, every week, or on any other schedule or in response to trigger events. As an example, the identity token 106 may be configured to expire twenty-four hours, seven days, or any other duration of time after it is generated and/or signed. Similarly, the public key material 116 stored in the public key repository 118 may be configured to expire twenty-four hours, seven days, or any other duration of time after it is used by the token signing service 126 to sign the identity token 106 or is stored in the public key repository 118.

Accordingly, if the first function 104 is a persistent element that continues to execute for a period of time such that a generated identity token 106 and/or corresponding public key material 116 expires, or is re-instantiated occasionally or periodically, the first function 104 and/or a corresponding credential manager may be configured to request a new identity token 106 via the gateway 120 and the token platform instance 102. In response to such a request, the gateway 120 may instantiate a new token platform instance 102, the new token platform instance 102 may generate a new identity token 106 and have the token signing service 126 sign the new identity token 106, the new token platform instance 102 may store new or updated public key material 116 associated with the new identity token 106 in the public key repository 118, and the new token platform instance 102 may provide the new identity token 106 to the first function 104 or the corresponding credential manager.

In some examples, multiple instances of the gateway 120, the public key repository 118, and/or other elements described herein may exist concurrently to serve as primary and/or backup instances, and/or to balance loads on individual instances. As an example, two instances of the gateway 120 may exist concurrently. Domain Name System (DNS) elements may be configured to route requests from the first function 104 and/or other functions to a first instance of the gateway 120, and the first instance of the gateway 120 may initiate the token platform instance 102 as needed to generate corresponding identity tokens 106 and to store corresponding instances of public key material 116 in one or more instances of the public key repository 118. However, if the first instance of the gateway 120 goes offline or experiences an error, the DNS elements may be configured to route subsequent requests from the first function 104 and/or other functions to the second instance of the gateway 120. Accordingly, rather than such requests failing due to issues with the first instance of the gateway 120, the second instance of the gateway 120 may initiate the token platform instance 102 as needed to generate corresponding identity tokens 106 and to store corresponding instances of public key material 116 in one or more instances of the public key repository 118.

As described above with respect to FIG. 1, in some examples the gateway 120 may instantiate the token platform instance 102 substantially immediately upon the gateway 120 receiving the cloud-native credential 114 and/or a corresponding request for an identity token 106, such that the instantiated token platform instance 102 may then execute to validate the cloud-native credential 114 via the credential validator 122, generate the identity token 106 via the token generator 124, and/or perform other operations. However, in some examples, the gateway 120 may be configured to evaluate a received cloud-native credential 114 and/or corresponding request for an identity token 106, in order to determine whether or not to instantiate the token platform instance 102 to perform subsequent operations, as described further below with respect to FIG. 2.

FIG. 2 shows a second example 200 of the system described herein, in which the gateway 120 may determine whether to cause the token platform instance 102 to provide the first function 104 with an identity token 106. The second example 200 of the system shown in FIG. 2 may be similar to the first example 100 of the system shown in FIG. 1, and may accordingly include elements that are the same or similar to elements described above with respect to FIG. 1. However, while in the first example 100 the gateway 120 may be configured to instantiate the token platform instance 102 directly in response to the gateway 120 receiving the cloud-native credential 114 and/or a corresponding request for an identity token 106, in the second example 200 shown in FIG. 2, the gateway 120 may be configured to determine whether or not to instantiate the token platform instance 102 in response to the gateway 120 receiving the cloud-native credential 114 and/or a corresponding request for an identity token 106.

For instance, in the second example 200 of the system, the gateway 120 may be configured to execute the credential validator 122 described above, and the token platform instance 102 may omit an instance of the credential validator 122. Accordingly, when the gateway 120 receives the cloud-native credential 114 associated with the first function 104, the gateway 120 may execute the credential validator 122 to validate the cloud-native credential 114. If the credential validator 122 executed by the gateway 120 indicates that the cloud-native credential 114 is valid, the gateway 120 may instantiate the token platform instance 102 in response to the successful validation of the cloud-native credential 114. As an example, the credential validator 122 of the gateway 120 may be configured to natively validate the cloud-native credential 114, or may use an IAM system or other element of the first cloud computing environment 110 to validate the cloud-native credential 114. The gateway 120 may then cause the token platform instance 102 to be instantiated in response to a successful validation of the cloud-native credential 114. However, if the credential validator 122 of the gateway 120 is unable to validate the cloud-native credential 114, the gateway 120 may avoid instantiating the token platform instance 102, and may reject a corresponding request for an identity token 106 associated with that cloud-native credential 114.

As shown in FIG. 2, the gateway 120 may also, or alternately, maintain a token cache 202. The token cache 202 may store copies of cloud-native credentials 114 associated with functions, and corresponding identity tokens 106 that have been generated for those functions by previously-instantiated token platform instances 102. Accordingly, in some situations, the gateway 120 may provide a function with a previously-generated identity token 106 that has been stored in the token cache 202, rather than instantiating the token platform instance 102 to generate a new identity token 106.

As an example, at a first time, the first function 104 may provide the cloud-native credential 114 to the gateway 120, and the gateway 120 may instantiate the token platform instance 102 such that the token platform instance 102 may generate an identity token 106, store corresponding public key material 116 in the public key repository 118, and return the identity token 106 to the first function 104 via the gateway 120. The gateway 120 may store that identity token 106, received from the token platform instance 102, in the token cache 202.

At a later second time, the first function 104 may again provide the cloud-native credential 114 to the gateway 120. The gateway 120 may, at the second time, determine that an identity token 106 associated with the received cloud-native credential 114 is already stored in the token cache 202. Accordingly, the gateway 120 may return the identity token 106 from the token cache 202 to the first function 104, instead of instantiating the token platform instance 102. Accordingly, the gateway 120 may provide the first function 104 with the previously-generated identity token 106 from the token cache 202 substantially immediately and without using time and/or computing resources to instantiate the token platform instance 102.

As discussed above, in some examples the first function 104 may be a temporary function that may exist for a relatively brief period of time, such as seconds or minutes. When the first function 104 terminates after a first period of time and is later instantiated again for a second period of time, the new instance of the first function 104 may be associated with the same cloud-native credential 114 as the previous instance of the first function 104. Accordingly, if the previous instance of the first function 104 already obtained an identity token 106 based on the cloud-native credential 114 via the token platform instance 102, the token cache 202 of the gateway 120 may already store that identity token 106. When the new instance of the first function 104 requests an identity token 106 by providing the same cloud-native credential 114 to the gateway 120, the gateway 120 may return the corresponding cached identity token 106 from the token cache 202 to the new instance of the first function 104, instead of instantiating the token platform instance 102.

Identity tokens 106 stored in the token cache 202 may be configured to expire after a certain period of time, such as a day, a week, or any other period of time, or may be removed from the token cache 202 after that period of time. Accordingly, if the first function 104 has previously obtained an identity token 106 via the gateway 120 and the token platform instance 102, but that identity token 106 has expired or has been removed from the token cache 202 by the next time the first function 104 provides the cloud-native credential 114 to the gateway 120, the gateway 120 may determine to instantiate the token platform instance 102 to generate a new identity token 106 as described herein.

The gateway 120 may also, or alternately, execute a request evaluator 204. The request evaluator 204 may be configured to evaluate a request for an identity token 106, and/or a corresponding cloud-native credential 114, received by the gateway 120, to determine whether the gateway 120 should instantiate the token platform instance 102 based on that request and/or cloud-native credential 114.

As an example, the request evaluator 204 may be configured to determine whether the request and/or the cloud-native credential 114 is in an acceptable format. For instance, if the request includes malformed header values, does not include one or more types of expected information, and/or includes other erroneous data, the request evaluator 204 may determine that the request is in an unacceptable format. If the request evaluator 204 determines that the request and/or the cloud-native credential 114 is in an acceptable format, the gateway 120 may determine to instantiate the token platform instance 102. However, if the request evaluator 204 determines that the request and/or the cloud-native credential 114 is not in an acceptable format, the gateway 120 may avoid instantiating the token platform instance 102 and may instead reject the request and/or the cloud-native credential 114.

As another example, the request evaluator 204 may be configured to count how many requests and/or instances of the cloud-native credential 114 the gateway 120 has received from the first function 104 or a corresponding credential manager over a period of time. The request evaluator 204 may determine whether the gateway 120 should instantiate the token platform instance 102 and/or perform other actions based on such a count of requests and/or instances of the cloud-native credential 114 received by the gateway 120 over the period of time.

For instance, if the first function 104 has sent more than a threshold number of requests for identity tokens 106 during a predefined period of time, the request evaluator 204 may determine that the first function 104 may be compromised or may be experiencing an error. The gateway 120 may accordingly avoid instantiating the token platform instance 102 to generate a new identity token 106 for the first function 104 and/or returning a previously-generated identity token 106 from the token cache 202 to the first function 104, and may instead return an error message or rejection message to the first function 104. However, if the first function 104 has not sent more than a threshold number of requests for identity tokens 106 during a predefined period of time, the gateway 120 may instantiate the token platform instance 102 to generate a new identity token 106 for the first function 104, or return a previously-generated identity token 106 from the token cache 202 to the first function 104.

In the second example 200 shown in FIG. 2, operations associated with elements such as the credential validator 122, the token cache 202, and the request evaluator 204 may occur at the persistent gateway 120 rather than at the temporary token platform instance 102. Accordingly, the token platform instance 102 may omit functionality associated with the credential validator 122, thereby reducing the size and/or complexity of the token platform instance 102 relative to examples in which the token platform instance 102 executes the credential validator 122. Such a reduction in the size and/or complexity of the token platform instance 102 may allow the token platform instance 102 to be instantiated and to execute other operations substantially immediately, for instance within 50 milliseconds. The token platform instance 102 may, for example, be a lightweight AWS Lambda function or other type of function, application, or process that omits the credential validator 122 and is instead streamlined to generate an identity token 106, have the identity token 106 signed by the credential validator 122, store the public key material 116 in the public key repository 118, return the signed identity token 106 via the gateway 120, and then terminate.

As discussed above with respect to FIG. 1, the token platform instance 102 may be coded using a compiled programming language, such as Golang, that also allows the token platform instance 102 to be instantiated and execute operations substantially immediately, for instance within 50 milliseconds. Additionally, as discussed above, if the token cache 202 of the gateway 120 already includes a previously-generated identity token 106, the gateway 120 may return that cached identity token 106 substantially immediately, for instance within 50 milliseconds, without instantiating the token platform instance 102 to generate a new identity token 106.

As discussed above with respect to the first example 100 and the second example 200 of the system, the first function 104 may request an identity token 106 by sending its cloud-native credential 114 to the gateway 120 associated with the token platform instance 102, and may use the returned identity token 106 to interact with the second function 108. However, in some examples, the first function 104 may have, or be associated with, a credential manager element that may interact with the gateway 120 and/or the second function 108 on behalf of the first function 104, as discussed further below with respect to FIG. 3.

FIG. 3 shows a third example 300 of the system described herein, in which a credential manager 302 associated with the first function 104 may interact with the gateway 120 and/or the second function 108. The third example 300 of the system shown in FIG. 3 may be similar to the first example 100 of the system shown in FIG. 1 and/or the second example 200 of the system shown in FIG. 2, and may accordingly include elements that are the same or similar to elements described above with respect to FIG. 1 and/or FIG. 2. However, while in some cases the first function 104 may interact directly with the gateway 120 and/or the second function 108 in the examples shown in FIG. 1 and FIG. 2, in the third example 300 the credential manager 302 associated with the first function 104 may interact with the gateway 120 and/or the second function 108.

The credential manager 302 may be a sidecar process, or other function or executable element that may be instantiated and/or executed alongside the first function 104 within the first cloud computing environment 110. The credential manager 302 may be configured to obtain the identity token 106 for the first function 104 via the gateway 120 and the token platform instance 102, and/or to use the identity token 106 to interact with the second function 108, as described herein. The credential manager 302 may be a preconfigured or predetermined element that is coded to interact with the gateway 120 and/or the second function 108 as described herein. Accordingly, developers of the first function 104 may use the credential manager 302 to obtain an identity token 106, and/or to obtain one or more access credentials 130 or otherwise interact with the second function 108, without coding the first function 104 to itself obtain the identity token 106 via the gateway 120 and/or to interact with the second function 108.

In some examples, the credential manager 302 may be created and/or executed in the same container or resource instance as the first function 104, such that the credential manager 302 is considered to have the same cloud-native credential 114 as the first function 104. For instance, if the first function 104 is a containerized Kubernetes process, the credential manager 302 may be created as a sidecar process in the same container as the first function 104. The cloud-native credential 114 may be associated with the container, such that the first function 104 and the credential manager 302 in the container are both associated with the cloud-native credential 114.

In other examples, the credential manager 302 may execute separately from the first function 104, but the first function 104 may be configured to call the credential manager 302 in order to have the credential manager 302 obtain the identity token 106 and/or one or more access credentials 130 on behalf of the first function 104. In these examples, the first function 104 may provide its cloud-native credential 114 to the credential manager 302 as part of the call to the credential manager 302, or the credential manager 302 may otherwise access or obtain the cloud-native credential 114 of the first function 104.

Overall, the credential manager 302 may provide the cloud-native credential 114 associated with the first function 104 to the gateway 120 as, or alongside, a request for an identity token 106. The gateway 120 and/or token platform instance 102 may process the cloud-native credential 114 as described above, for instance to generate and/or return an identity token 106 associated with the first function 104. Accordingly, the gateway 120 may return the requested identity token 106 to the credential manager 302, for instance after having instantiated the token platform instance 102 and receiving the identity token 106 from the token platform instance 102, or by retrieving the identity token 106 from the token cache 202.

The credential manager 302 may be configured to store the received identity token 106 in a credential cache 304, such as a database or other data repository that is accessible by the credential manager 302 and/or the first function 104. Accordingly, the identity token 106 may be stored and available for later use by the first function 104 and/or the credential manager 302.

In some examples, the credential manager 302 may be configured to request the identity token 106 via the gateway 120 substantially immediately upon initiation or instantiation of the first function 104, such that the identity token 106 may be proactively obtained by the credential manager 302 before the first function 104 and/or the credential manager 302 needs to use the identity token 106 to interact with the second function 108 or other elements. The credential manager 302 may also, or alternately, be configured to re-request new identity tokens 106 via the gateway 120 periodically, occasionally, or in response to one or more trigger conditions, for instance so that the credential manager 302 may obtain and store new identity tokens 106 at or before expiration of previously-obtained identity tokens 106.

The credential manager 302 may also, and/or alternately, be configured to provide an identity token 106, received from the gateway 120 and/or the token platform instance 102, to the second function 108 in order to allow the first function 104 to interact with the second function 108 and/or obtain one or more access credentials 130 from the second function 108. As described herein, the identity token 106 may allow the second function 108 to verify the signature of the identity token 106 by retrieving the public key material 116 that had been used to sign the identity token 106 from the public key repository 118. Accordingly, the second function 108 may verify the identity of the first function 104 and/or the credential manager 302 based on the identity token 106, such that the second function 108 may permit further interactions between the second function 108 and the first function 104 and/or the credential manager 302.

In some examples, the credential manager 302 may be configured to use the identity token 106 to request and obtain one or more access credentials 130 from the second function 108. As described above, the first function 104 may be configured to interact with one or more third functions 132, and the first function 104 may use corresponding access credentials 130 obtained from the second function 108 to access those third functions 132. In the third example 300 shown in FIG. 3, the credential manager 302 may use the identity token 106 to request such access credentials 130, associated with respective third functions 132, for and/or on behalf of the first function 104. The credential manager 302 may store the received access credentials 130 in the credential cache 304, such that the access credentials 130 may be stored and available for later use by the first function 104 and/or the credential manager 302.

As an example, the first function 104 may be an application that is capable of interacting with numerous third functions 132. Each of the third functions 132 may be configured to authenticate or validate the first function 104 based on respective different access credentials 130 that are managed or provided by the second function 108, instead of based on the cloud-native credential 114 or the identity token 106. The credential manager 302 may obtain an identity token 106 via the gateway 120 and the token platform instance 102 as described herein, and may use that identity token 106 to obtain, from the second function 108, one or more access credentials 130 that are associated with respective third functions 132. The credential manager 302 may store those access credentials 130 in the credential cache 304, such that the first function 104 may use the stored access credentials 130 if and/or when the first function 104 later interacts with the respective third functions 132.

In some examples, the credential manager 302 may be configured to proactively obtain the identity token 106, and proactively use the identity token 106 to obtain one or more access credentials 130, substantially immediately upon initiation or instantiation of the first function 104. As a non-limiting example, the first function 104 may be coded to potentially interact with fifty different third functions 132. In this example, when the first function 104 is first instantiated, the credential manager 302 may be configured to proactively obtain the identity token 106 and to use that identity token 106 to proactively obtain a set of fifty different access credentials 130 that the first function 104 may need to later interact with the fifty different third functions 132. Accordingly, if and when the first function 104 does need to interact with any of the fifty different third functions 132, the credential cache 304 may already store a corresponding access credential 130 obtained by the credential manager 302 from the second function 108. The first function 104 and the credential manager 302 may thus avoid making a new request to the second function 108 for a new access credential 130 each time the first function 104 needs to interact with a new third function 132.

The credential manager 302 may also be configured to obtain new access credentials 130 from the second function 108 periodically, occasionally, or in response to trigger conditions. For example, the credential manager 302 may periodically obtain new access credentials 130 from the second function 108, to avoid maintaining expired access credentials 130 in the credential cache 304. As another example, the credential manager 302 may be configured to obtain new access credentials 130 from the second function 108 when the credential manager 302 obtains a new identity token 106 via the gateway 120 and the token platform instance 102.

The credential manager 302 may be configured to handle one or more types of error conditions or other situations. For example, if the credential manager 302 provides the cloud-native credential 114 to the gateway 120 and does not receive an identity token 106 in response within a threshold period of time, the credential manager 302 may be configured to retry obtaining an identity token 106 via the gateway, for instance by re-sending the cloud-native credential 114 to the gateway 120 one or more times at regular intervals, at irregular intervals determined via an exponential backoff scheme, and/or at other times. Similarly, if the credential manager 302 provides the identity token 106 to the second function 108 and does not receive a response, or one or more access credentials 130, from the second function 108 within a threshold period of time, the credential manager 302 may be configured to re-send the identity token 106 to the second function 108 one or more times at regular intervals, at irregular intervals determined via an exponential backoff scheme, and/or at other times.

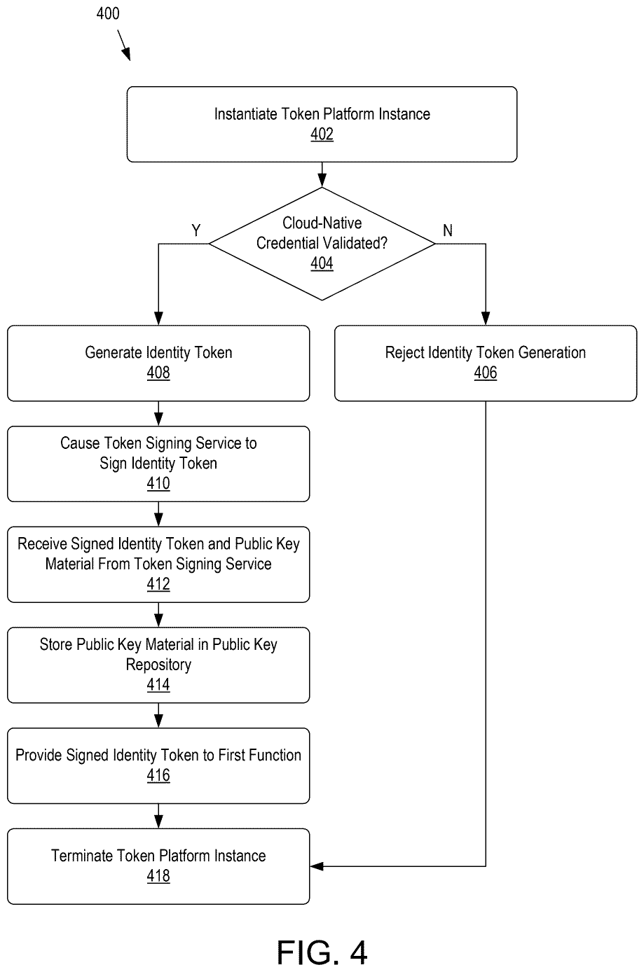

The credential manager 302 may accordingly be a sidecar function or other element that is pre-configured to interact with the gateway 120 and/or the second function 108 to obtain and/or manage identity tokens 106 and/or access credentials 130 on behalf of the first function 104. Accordingly, developers of the first function 104 may configure the first function 104 to use the pre-configured credential manager 302 to obtain and/or manage identity tokens 106 and/or access credentials 130, instead of coding the first function 104 itself with functionality for obtaining and/or managing identity tokens 106 and/or access credentials 130. Source code and/or executable files associated with the first function 104 may accordingly be simplified and/or smaller in size, and/or the first function 104 may execute using fewer computing resources, relative to coding the first function 104 to itself obtain and/or manage identity tokens 106 and/or access credentials 130. However, as discussed above with respect to FIG. 1 and FIG. 2, in other examples the first function 104 may itself be configured to interact directly with the gateway 120 and/or the second function 108. Example interactions between elements described herein are also discussed further below with respect to FIGS. 4-7.

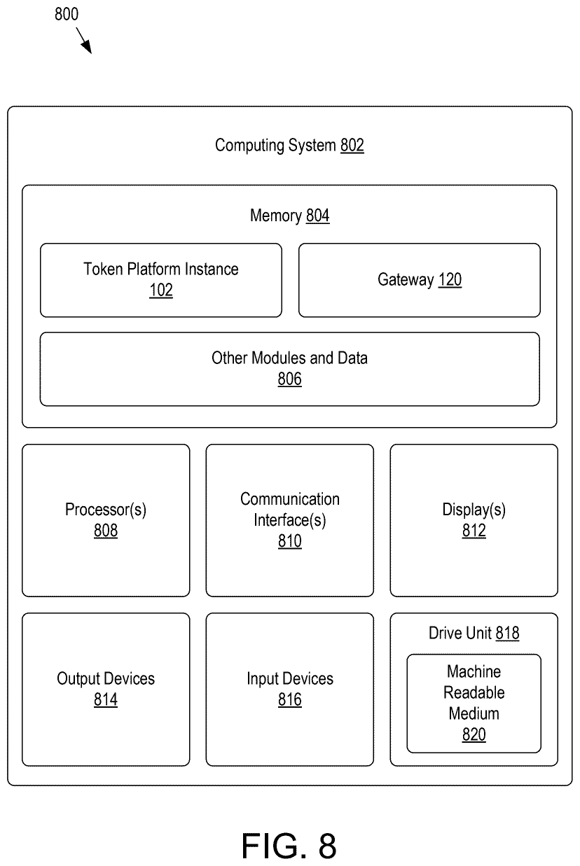

FIG. 4 shows a flowchart illustrating an example method 400 for generating the identity token 106 for the first function 104 via the token platform instance 102. The method 400 shown in FIG. 4 may be a computer-implemented method performed via a computing system that executes the token platform instance 102. In some examples, the computing system that executes the token platform instance 102 may include, or be executed via, physical and/or virtual computing resources of a cloud computing system. An example system architecture for such a computing system is described below with respect to FIG. 8.

At block 402, the computing system may instantiate the token platform instance 102. The token platform instance 102 may be a temporary element, such as a temporary element that may be instantiated on demand via physical and/or virtual computing resources. Accordingly, the computing system may allocate physical and/or virtual computing resources to the token platform instance 102, and use the allocated computing resources to spin up and begin executing the token platform instance 102.

The computing system may instantiate the token platform instance 102 in response to a request from the gateway 120. For example, the first function 104 or the credential manager 302 may have provided the gateway 120 with the cloud-native credential 114 that identifies the first function 104 within the first cloud computing environment 110, for instance as part of a request for an identity token 106 that is cloud agnostic and may be used outside the first cloud computing environment 110. In response to such a request and/or the receipt of the cloud-native credential 114, the gateway 120 may request that the computing system temporarily instantiate the token platform instance 102 at block 402.

At block 404, the token platform instance 102 may attempt to validate the cloud-native credential 114 associated with the first function 104. The first function 104 or the credential manager 302 may have provided the cloud-native credential 114 to the gateway 120, and the gateway 120 may have provided the cloud-native credential 114 to the token platform instance 102. As discussed above, the cloud-native credential 114 may natively identify the first function 104 within the first cloud computing environment 110. Accordingly, if the token platform instance 102 is also instantiated in the first cloud computing environment 110, the token platform instance 102 may be configured to natively understand the cloud-native credential 114, or may be configured to use a native identity service of the first cloud computing environment 110, in order to validate the cloud-native credential 114 of the first function 104. In other examples in which the token platform instance 102 is instantiated in a different computing environment, the token platform instance 102 may be configured to interact with an identity service of the first cloud computing environment 110 to validate the cloud-native credential 114 and/or use other systems or techniques to validate the cloud-native credential 114 of the first function 104.

If the token platform instance 102 is unable to validate the cloud-native credential 114 of the first function 104 (Block 404—No), the token platform instance 102 may reject generation of an identity token 106 for the first function 104 at block 408. However, if the token platform instance 102 is able to validate the cloud-native credential 114 of the first function 104 (Block 404—Yes), the token platform instance 102 may generate the identity token 106 for the first function 104 at block 408. In some examples, the identity token 106 generated at block 408 may be a SPIFFE token or other cloud-agnostic identity credential.

At block 410, the token platform instance 102 may cause the separate token signing service 126 to cryptographically sign the identity token 106 generated at block 408. For example, the token platform instance 102 may send the identity token 106 to the token signing service 126, and request that the token signing service 126 sign the identity token 106. The token signing service 126 may be a separate service that is external to the token platform instance 102, such that the token platform instance 102 does not have visibility into the internal operations of the token signing service 126. For instance, although the token signing service 126 may internally generate public key material 116 and a private key 128, and use the public key material 116 and the private key 128 to sign the identity token 106, the token signing service 126 may be configured to keep the private key 128 secret and not expose the private key 128 to the token platform instance 102 or any other element.

At block 412, the token platform instance 102 may receive the signed identity token 106 from the token signing service 126, along with the public key material 116 used by the token signing service 126 to sign the identity token 106. The public key material 116 may be a public key, a set of one or more certificates, or other data. The public key material 116 may be used to verify a digital signature of the identity token 106 that was created at least in part based on the corresponding private key 128. However, although the token signing service 126 may use the public key material 116 and the private key 128 to sign the identity token 106, the token signing service 126 may keep the private key 128 secret. The token signing service 126 may accordingly send the public key material 116 to the token platform instance 102 at block 412, but may avoid exposing the corresponding private key 128 to the token platform instance 102.

At block 414, the token platform instance 102 may store the public key material 116, received from the token signing service 126 at block 412, in the public key repository 118. For example, the token platform instance 102 may publish the public key material 116 to the public key repository 118, transfer the public key material 116 to the public key repository 118, or otherwise store the public key material 116 in the public key repository 118. The public key repository 118 may associate the public key material 116 with a corresponding name, number, or other identifier of the first function 104 or the identity token 106.

At block 416, the token platform instance 102 may provide the signed identity token 106, received from the token signing service 126 at block 412, to the first function 104 or the credential manager 302. In some examples, the token platform instance 102 may provide the signed identity token 106 to the gateway 120, and the gateway 120 may provide the signed identity token 106 to the first function 104 or the credential manager 302. As described above with respect to FIG. 2, in some examples the gateway 120 may also store the signed identity token 106 in the token cache 202, such that the gateway 120 may later provide the identity token 106 to the first function 104 or the credential manager 302 from the token cache 202 instead of re-instantiating the token platform instance 102 to generate a new identity token 106.

After storing the public key material 116 in the public key repository 118 at block 414 and providing the identity token 106 to the first function 104 or the credential manager 302 at block 416, or if the token platform instance 102 could not validate the cloud-native credential 114 at block 404 and rejected generation of the identity token 106 at block 406, the token platform instance 102 may terminate at block 418. For example, the computing system that instantiated the token platform instance 102 may terminate the token platform instance 102, de-allocate physical and/or virtual computing resources that had been allocated to the token platform instance 102, and/or otherwise cease operations of the token platform instance 102.

Accordingly, the token platform instance 102 may be a temporary element instead of a more permanent element, such as a SPIRE server, that executes continuously and consumes memory, computing cycles, and/or other computing resources over time. Moreover, unlike a SPIRE server that executes continuously and may itself sign a SPIFFE token that is generated and/or managed by the SPIRE server, the token platform instance 102 may be configured to use the external token signing service 126 such that the token platform instance 102 does not receive the private key 128 associated with the identity token 106. Accordingly, security of the identity token 106 may be enhanced via usage of the token platform instance 102, because the token platform instance 102 does not have access to the private key 128 and may terminate after it stores the public key material 116 in the public key repository 118 and provides the identity token 106 to the first function 104 via the gateway 120.

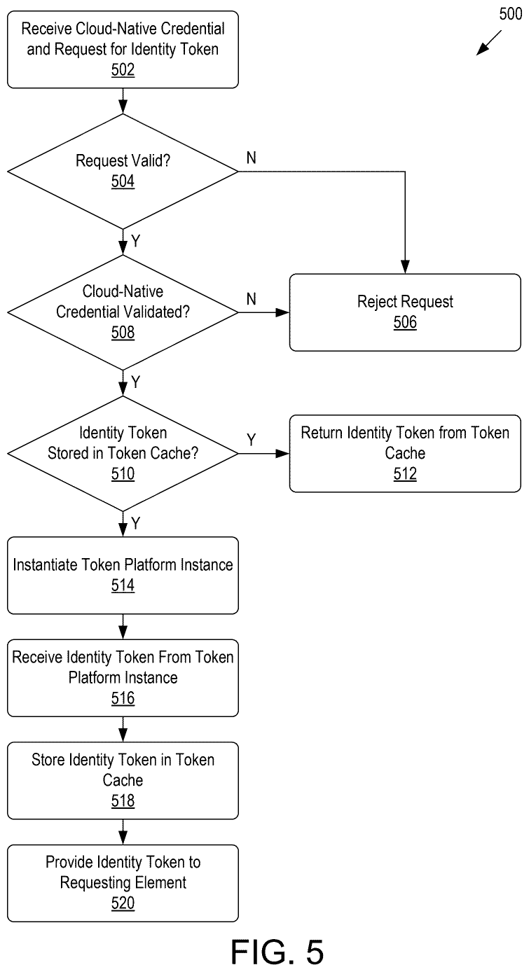

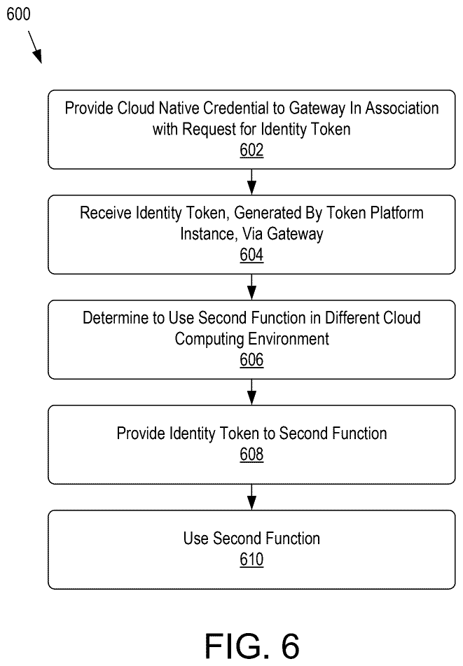

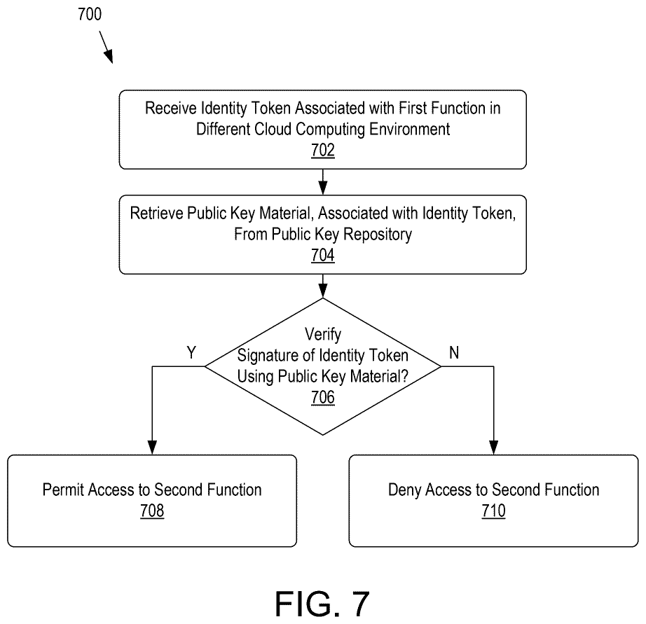

After the token platform instance 102 provides the identity token 106 to the first function 104 or the credential manager 302 at block 416, the first function 104 or the credential manager 302 may use the identity token 106 to verify the identity of the first function 104 with other elements, such as the second function 108, in other cloud computing environments. Examples of respective actions of the first function 104 and the second function 108 in association with the identity token 106 are discussed below with respect to FIG. 6 and FIG. 7. Although FIG. 4 shows the token platform instance 102 attempting to validate the cloud-native credential 114 after the token platform instance 102 has been instantiated, in other examples the gateway 120 may perform the validation of the cloud-native credential 114, and/or other operations, before instantiating the token platform instance 102, as described further below with respect to FIG. 5.

FIG. 5 shows a flowchart illustrating an example method 500 for instantiating the token platform instance 102. The method 500 shown in FIG. 5 may be a computer-implemented method performed via a computing system that executes the gateway 120. In some examples, the computing system that executes the gateway 120 may include, or be executed via, physical and/or virtual computing resources of a cloud computing system. An example system architecture for such a computing system is described below with respect to FIG. 8.

At block 502, the gateway 120 may receive the cloud-native credential 114 associated with the first function 104, as part of or along with a request for an identity token 106, from a requesting element. The requesting element may be the first function 104, or the credential manager 302 that may be configured to obtain the identity token 106 on behalf of the first function 104.

At block 504, the gateway 120 may determine whether the request received at block 502 is valid. For example, the request evaluator 204 of the gateway 120 may determine whether the request has a malformed header or is otherwise in an invalid format, or if more than a threshold number of requests has been received from the requesting element within a period of time. If the gateway 120 determines that the request is in an invalid format, determines that more than the threshold number of requests has been received within the period of time, or otherwise determines that the request is invalid (Block 504—No), the gateway 120 may reject the request at block 506 and method 500 may end. Accordingly, the gateway 120 may reject the generation of an identity token 106 associated with the first function 104 at block 506, and may accordingly avoid causing the token platform instance 102 to be instantiated.

However, if the gateway 120 determines that the request is in a valid format, determines that more than the threshold number of requests has not been received within the period of time, or otherwise determines that the request is valid (Block 504—Yes), the gateway 120 may move to block 508. At block 508, the gateway 120 may attempt to validate the cloud-native credential 114. For example, as discussed above with respect to FIG. 2, the gateway 120 may use an instance of the credential validator 122 to attempt to validate the cloud-native credential 114 before the gateway 120 determines whether or not to instantiate the token platform instance 102.

If the gateway 120 is unable to validate the cloud-native credential 114 (Block 508—No), the gateway 120 may reject the request at block 506 and method 500 may end. Accordingly, the gateway 120 may reject the generation of an identity token 106 associated with the first function 104 at block 506, and may accordingly avoid causing the token platform instance 102 to be instantiated.

However, if the gateway 120 is able to validate the cloud-native credential 114 (Block 508—Yes), the gateway 120 may determine whether the requested identity token 106 is already stored in the token cache 202 of the token platform instance 102. For example, if the identity token 106 was previously requested and generated, and the identity token 106 has not expired, the token cache 202 may already store a valid identity token 106 associated with the first function 104.

Accordingly, if a valid identity token 106 associated with the first function 104 is already stored in the token cache 202 (Block 510—Yes), the gateway 120 may return the identity token 106 from the token cache 202 to the requesting element, such as the first function 104 or the credential manager 302, at block 512 and method 500 may end. Accordingly, the gateway 120 may return a copy of a previously-generated identity token 106 associated with the first function 104 at block 512, and may accordingly avoid causing the token platform instance 102 to be instantiated in order to generate a new identity token 106.

However, if a valid identity token 106 associated with the first function 104 is not stored in the token cache 202 (Block 510—No), the gateway 120 may cause the token platform instance 102 to be instantiated at block 514. The gateway 120 may also pass the cloud-native credential 114 and/or the request for the identity token 106 to the instantiated token platform instance 102, such that the token platform instance 102 may generate the identity token 106 for the first function 104 and perform other operations as described above with respect to block 408 through block 416 of FIG. 4.

At block 516, the gateway 120 may receive the identity token 106 generated by the token platform instance 102. The token platform instance 102 may have caused the identity token 106 to be signed by the token signing service 126, and may have stored public key material 116 associated with the identity token 106 in the public key repository 118. The token platform instance 102 may provide the identity token 106 to the gateway 120 at block 516, before the token platform instance 102 terminates.

At block 518, the gateway 120 may store the received identity token 106 in the token cache 202. Accordingly, at a later time, if the identity token 106 is requested again via the gateway 120, the gateway 120 may determine that the identity token 106 is already stored in the token cache 202 at block 510, and the gateway 120 may avoid re-instantiating the token platform instance 102 again by returning the cached identity token 106 to the requesting element at block 512.

At block 520, instead of or in addition to storing the received identity token 106 in the token cache 202 at block 518, the gateway 120 may provide the received identity token 106 to the element that sent the cloud-native credential 114 and/or the corresponding request for the identity token 106 that was received at block 502. For example, the gateway 120 may return the identity token 106 to the first function 104 or the credential manager 302. Accordingly, the first function 104 or the credential manager 302 may use the identity token 106 to interact with the second function 108 and/or other elements, for example as discussed further below with respect to FIG. 6 and FIG. 7.

FIG. 6 shows a flowchart illustrating an example method 600 for obtaining and using an identity token 106, associated with the first function 104, generated by the token platform instance 102. The method 600 shown in FIG. 6 may be a computer-implemented method performed via a computing system that executes the first function 104 or the credential manager 302, such as a computing system that includes or uses one or more physical and/or virtual computing resources of the first cloud computing environment 110. An example system architecture for such a computing system is described below with respect to FIG. 8.

In some examples, the first function 104 may be a temporary element that is instantiated in the first cloud computing environment 110 and executes for a relatively short period of time, such as seconds, minutes, or hours, before being terminated. In other examples, the first function 104 may be continuously or persistently executed in the first cloud computing environment 110. In some examples, the first function 104 may be associated with a credential manager 302, such as a sidecar process, that may obtain and/or manage credentials for the first function 104.

The first cloud computing environment 110 may associate the first function 104 and/or the credential manager 302 with a corresponding cloud-native credential 114 that is configured to identify the first function 104 and/or the credential manager 302 to other elements within the first cloud computing environment 110. However, the computing system may use the method 600 to obtain a cloud-agnostic identity token 106 that may identify the first function 104 and/or the credential manager 302 to elements outside of the first cloud computing environment 110, such as the second function 108 in the second cloud computing environment 112.

At block 602, the computing system may provide the cloud-native credential 114 to the gateway 120, for instance in association with a request for the cloud-agnostic identity token 106. The gateway 120 may be an API gateway or other element that is configured to listen for such cloud-native credentials 114 and/or requests from functions, and/or to cause corresponding token platform instances 102 to be instantiated in response to receipt of such cloud-native credentials 114 and/or requests.

In some examples, when the computing system provides the cloud-native credential 114 to the gateway 120 at block 602, the gateway 120 may cause a token platform instance 102 to be instantiated as discussed above with respect to the method 400 shown in FIG. 4. The gateway 120 may also pass the cloud-native credential 114 to the newly-instantiated token platform instance 102. Accordingly, as discussed above with respect to the method 400 shown in FIG. 4, the token platform instance 102 may validate the cloud-native credential 114, generate the corresponding identity token 106, have the identity token 106 signed by the token signing service 126, store the public key material 116 in the public key repository 118, and provide the signed identity token 106 to the gateway 120 before the token platform instance 102 terminates.

In other examples, when the computing system provides the cloud-native credential 114 to the gateway 120 at block 602, the gateway 120 may validate the cloud-native credential 114 and/or perform other operations to evaluate the request for the identity token 106, for example as discussed above with respect to the method 500 shown in FIG. 5. The gateway 120 may cause the token platform instance 102 to be instantiated in response to a successful validation of the cloud-native credential 114 and/or a determination that the request for the identity token 106 is valid, such that the token platform instance 102 generates the identity token 106 for the first function 104, has the identity token 106 signed by the token signing service 126, stores the public key material 116 in the public key repository 118, and provides the signed identity token 106 to the gateway 120 before the token platform instance 102 terminates.

At block 604, the computing system that executes the first function 104 and/or the credential manager 302 may accordingly receive the identity token 106, generated by the token platform instance 102 and signed via the token signing service 126, from the gateway 120. The identity token 106 may be a cloud-agnostic credential, such as a SPIFFE token, that indicates the identity of the first function 104 and/or the credential manager 302.

At block 606, the computing system that executes the first function 104 and/or the credential manager 302 in the first cloud computing environment 110 may determine to use the second function 108 in the second cloud computing environment 112. For example, the first function 104 and/or the credential manager 302 in the first cloud computing environment 110 may be configured to perform one or more operations that involve interactions with the second function 108, for instance to send data to the second function 108 and/or receive data from the second function 108, even though the second function 108 is executed in a different cloud computing environment. The second function 108 may be configured to verify the identity of the first function 104 and/or the credential manager 302 before the first function 104 and/or the credential manager 302 may use the second function 108.

Accordingly, to confirm the identity of the first function 104 and/or the credential manager 302 to the second function 108, the first function 104 and/or the credential manager 302 may provide the identity token 106 received at block 604 to the second function 108 at block 608. The second function 108 may retrieve the public key material 116 associated with the identity token 106 from the public key repository 118, and use the public key material 116 to verify the signature of the identity token 106 and thus the identity of the first function 104 and/or the credential manager 302, as discussed further below with respect to FIG. 7.

After the second function 108 has used the identity token 106 to verify the identity of the first function 104 and/or the credential manager 302, the first function 104 and/or the credential manager 302 may use the second function 108 at block 610, for instance to access or use one or more services provided by the second function 108. In some examples, the second function 108 may determine access privileges of the first function 104 and/or the credential manager 302, such as which services of the second function 108 the first function 104 and/or the credential manager 302 are permitted to use, based on the verified identity of the first function 104 and/or the credential manager 302 as discussed further below with respect to FIG. 7. In some examples, the second function 108 may issue one or more access credentials 130 to the first function 104 and/or the credential manager 302 in response to verifying the identity of the first function 104 and/or the credential manager 302 based on the identity token 106. Accordingly, the first function 104 and/or the credential manager 302 may use the access credentials 130 during further interactions with the second function 108 instead of or in addition to the identity token 106, and/or during interactions with one or more third functions 132 that may be permitted based on respective access credentials 130 obtained from the second function 108.

In some examples, the first function 104 and/or the credential manager 302 may repeat the method 600 shown in FIG. 6. As discussed above, in some examples the identity token 106 may expire after one hour, or any other period of time. Accordingly, although the first function 104 may be a temporary element in some examples, if the first function 104 is still in existence after the identity token 106 expires, the first function 104 may use the method 600 to obtain and use a new identity token 106. Similarly, the credential manager 302 may repeat the method 600 at one or more times to obtain respective new identity tokens 106 for the first function 104.

In some examples in which the first function 104 is a temporary element, the first function 104 may perform operations involving interactions with the second function 108 and/or other operations, and then terminate. Accordingly, the first function 104 may obtain the identity token 106 and use the identity token 106 to verify the identity of the first function 104 with the second function 108 that executes in a different cloud computing environment substantially immediately after, or relatively soon after, the first function 104 is instantiated. Accordingly, although the first function 104 may execute via physical and/or virtual computing resources that are temporarily allocated to the first function 104 within the first cloud computing environment 110, the first function 104 may obtain and use the identity token 106 without a separate token manager, such as a SPIRE agent, being installed on and executing on the physical and/or virtual computing resources used to execute the first function 104.

FIG. 7 shows a flowchart illustrating an example method 700 for the second function 108 to verify the identity of the first function 104 based on the identity token 106 generated by the token platform instance 102. The method 700 shown in FIG. 7 may be a computer-implemented method performed via a computing system that executes the second function 108, such as a computing system that includes or uses one or more physical and/or virtual computing resources of the second cloud computing environment 112. An example system architecture for such a computing system is described below with respect to FIG. 8.

At block 702, the second function 108 may receive the identity token 106 from the first function 104 or the credential manager 302 associated with the first function 104. As discussed above, although the first function 104 and/or the credential manager 302 may execute in a different cloud computing environment, the identity token 106 may be a cloud-agnostic credential, such as a SPIFFE token, that may be used to verify the identity of the first function 104 and/or the credential manager 302. The second function 108 may receive the identity token 106 from the first function 104 or the credential manager 302 in association with a request to access or use the second function 108. For instance, the first function 104 may request to use one or more services provided by the second function 108, or the first function 104 and/or the credential manager 302 may request one or more access credentials 130 from the second function 108 so that the first function 104 may use those access credentials 130 to interact with respective third functions 132. The second function 108 may be configured to verify the identity of the first function 104 and/or the credential manager 302 before permitting the first function 104 and/or the credential manager 302 to use services provided by the second function 108 and/or to obtain one or more access credentials 130 from the second function 108.

At block 704, the second function 108 may retrieve public key material 116 associated with the identity token 106 from the public key repository 118. As discussed above with respect to method 400 shown in FIG. 4, the token platform instance 102 that generated the identity token 106 may have stored the corresponding public key material 116 at the public key repository 118 before the token platform instance 102 terminated. Accordingly, although the token platform instance 102 may have previously terminated, the second function 108 may nevertheless obtain the public key material 116 associated with the identity token 106 from the public key repository 118.

At block 706, the second function 108 may use the public key material 116 to attempt to verify the digital signature of the identity token 106. The public key material 116 may include a public key, a set of one or more certificates, or other data. Although the token signing service 126 may have signed the identity token 106 with a private key 128 that was not exposed to the token platform instance 102 or other elements, the corresponding public key material 116 may be configured to allow the second function 108 to verify the validity of the digital signature of the identity token 106.

If the second function 108 is able to use the public key material 116 to verify the signature of the identity token 106 (Block 706—Yes), the second function 108 may determine that the identity token 106 accurately indicates the identity of the first function 104 and/or the credential manager 302, and may accordingly permit the first function 104 and/or the credential manager 302 to access services of the second function 108 at block 708. In some examples, the second function 108 may use the validated identity of the first function 104 and/or the credential manager 302 to determine access permissions associated with the first function 104 and/or the credential manager 302, such as which particular services and/or data the first function 104 and/or the credential manager 302 is permitted to access or use via the second function 108.

The second function 108 may issue one or more access credentials 130 to the first function 104 and/or the credential manager 302, in response to the second function 108 verifying the identity of the first function 104 and/or the credential manager 302 based on the identity token 106. In some examples, the first function 104 and the second function 108 may use such an access credential 130 during subsequent interactions, instead of or in addition to the identity token 106. In other examples, the first function 104 and/or the credential manager 302 may obtain one or more access credentials 130 associated with respective third functions 132 from the second function 108, such that the first function 104 may subsequently use those access credentials 130 to interact with respective third functions 132.

If the second function 108 is unable to use the public key material 116 to verify the signature of the identity token 106 (Block 706—No), the second function 108 may deny the first function 104 and/or the credential manager 302 access to the second function 108 at block 710.

FIG. 8 shows an example system architecture 800 for a computing system 802 that may execute the token platform instance 102 and/or other elements described herein. The computing system 802 can include one or more computers, servers, or other types of computing devices.

The computing system 802 may be associated with a cloud computing environment, and may include servers or other computing devices that provide physical resources and/or virtual resources that may host and/or execute elements. For example, hardware of the computing system 802 may be used to provide virtual computing resources, such as containers or virtual machines, that may host and/or execute elements described herein.

In some examples, elements described herein may be distributed among, and/or be executed by, multiple computing systems or devices similar to the computing system 802 shown in FIG. 8. Such computing systems or devices may be part of a cloud computing environment or other computing environment.

As an example, the token platform instance 102, the first function 104, the second function 108, the gateway 120, the token signing service 126, the public key repository 118, one or more third functions 132, the credential manager 302, and/or other elements may be hosted and/or executed by computing elements of cloud computing environments, for instance via servers, virtual machines, containers, and/or other physical and/or virtual computing resources of the cloud computing environments. Such physical and/or virtual computing resources may include, or may be hosted and/or executed by, one or more computing systems or devices that have the architecture shown in FIG. 8 or a similar architecture.

The computing system 802 may include memory 804. In various examples, the memory 804 may include system memory, which may be volatile (such as RAM), non-volatile (such as ROM, flash memory, etc.) or some combination of the two. The memory 804 may further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which may be used to store desired information and which may be accessed by the computing system 802. Any such non-transitory computer-readable media may be part of the computing system 802.

The memory 804 may store data and/or computer-executable instructions, such as data and/or computer-executable instructions associated with software elements. For instance, the memory 804 may store data and/or computer-executable instructions associated with the token platform instance 102 and/or other elements described herein.

As an example, the memory 804 may store an image of the token platform instance 102. When the gateway 120 requests that the token platform instance 102 be instantiated, the computing system 802 may allocate memory 804 and physical and/or virtual computing resources for the token platform instance 102, and may use the image to instantiate the token platform instance 102. When the token platform instance 102 terminates, memory 804 and physical and/or virtual computing resources that had been allocated to the token platform instance 102 may be re-allocated for other uses.

The memory 804 may also store other modules and data 806 that may be utilized by the computing system 802 to perform or enable performing any action taken by the computing system 802. For example, the other modules and data 806 may include a platform, operating system, and/or applications, as well as data utilized by the platform, operating system, and/or applications.

The computing system 802 may also have processor(s) 808, communication interfaces 810, a display 812, output devices 814, input devices 816, and/or a drive unit 818 including a machine readable medium 820.

In various examples, the processor(s) 808 may be a central processing unit (CPU), a graphics processing unit (GPU), both a CPU and a GPU, or any other type of processing unit. Each of the one or more processor(s) 808 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 808 may also be responsible for executing computer applications stored in the memory 804, which may be associated with types of volatile (RAM) and/or nonvolatile (ROM) memory.

The communication interfaces 810 may include transceivers, modems, network interfaces, antennas, and/or other components that may transmit and/or receive data over networks or other connections. In some examples, the communication interfaces 810 may be used to exchange data between elements described herein.

The display 812 may be a liquid crystal display, or any other type of display commonly used in computing devices. The output devices 814 may include any sort of output devices known in the art, such as the display 812, speakers, a vibrating mechanism, and/or a tactile feedback mechanism. Output devices 814 may also include ports for one or more peripheral devices, such as headphones, peripheral speakers, and/or a peripheral display.

The input devices 816 may include any sort of input devices known in the art. For example, input devices 816 may include a microphone, a keyboard/keypad, and/or a touch-sensitive display, such as a touch-sensitive display screen. A keyboard/keypad may be a push button numeric dialing pad, a multi-key keyboard, or one or more other types of keys or buttons, and may also include a joystick-like controller, designated navigation buttons, or any other type of input mechanism.

The machine readable medium 820 may store one or more sets of instructions, such as software or firmware, that embodies any one or more of the methodologies or functions described herein. The instructions may also reside, completely or at least partially, within the memory 804, processor(s) 808, and/or communication interface(s) 810 during execution thereof by the computing system 802. The memory 804 and the processor(s) 808 also may constitute machine readable media 820.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method for identity access management, comprising:
receiving, by a gateway, a cloud-native credential that indicates an identity of a function executing within a cloud computing environment, wherein:
the cloud-native credential is received in association with a request for an identity token, associated with the function, that comprises a cloud-agnostic credential;
determining, by the gateway, to instantiate a token platform instance based at least in part on validating the cloud-native credential;
instantiating, by the gateway, the token platform instance, wherein the token platform instance comprises a temporary computer-executable element configured to:
generate the identity token;
cause a token signing service to sign the identity token with a digital signature;
receive, from the token signing service, public key material associated with the digital signature; and
store the public key material in a public key repository;
receiving, by the gateway, the identity token from the token platform instance; and
providing, by the gateway, the identity token to the function or a credential manager associated with the function.

2. The computer-implemented method of claim 1, wherein the token platform instance is configured to terminate after storing the public key material in the public key repository and providing the identity token to the gateway.

3. The computer-implemented method of claim 1, wherein the gateway is further configured to determine to instantiate the token platform instance based on at least one of:
determining that the request is in a valid format, or
determining that a number of requests for the identity token, over a period of time, is less than a threshold number.

4. The computer-implemented method of claim 1, wherein:
the function or the credential manager is configured to provide the identity token to a second function that executes in a second cloud computing environment, and
the second function is configured to verify the identity of the function by:
retrieving the public key material from the public key repository, and
using the public key material to verify the digital signature of the identity token.

5. The computer-implemented method of claim 4, wherein the second function is configured to provide an access credential to the function or the credential manager in response to verifying the identity of the function based on the identity token.

6. The computer-implemented method of claim 5, wherein the access credential is configured to permit interactions between the function and a third function.

7. The computer-implemented method of claim 5, wherein the credential manager comprises a sidecar element that executes with the function within the cloud computing environment, and is configured to:
obtain the identity token, via the gateway, for the function; and
obtain the access credential, via the second function, for the function.

8. The computer-implemented method of claim 1, further comprising:
storing, by the gateway, and at a first time, the identity token in a token cache of the gateway;
receiving, by the gateway, and at a second time, the cloud-native credential in association with a second request for the identity token;
returning, by the gateway, the identity token from the token cache in response to the second request; and
avoiding, by the gateway, re-instantiating the token platform instance in response to the second request.

9. The computer-implemented method of claim 1, wherein the identity token comprises a Secure Production Identity Framework for Everyone (SPIFFE) token.

10. The computer-implemented method of claim 1, wherein the function comprises a serverless executable element instantiated via computing resources of the cloud computing environment.

11. The computer-implemented method of claim 1, wherein the token platform instance is instantiated based on a compiled programming language.

12. One or more non-transitory computer-readable media storing computer-executable instructions associated with an identity access management system that, when executed by one or more processors of a computing system, cause the computing system to:
receive, by a gateway, a cloud-native credential that indicates an identity of a function executing within a cloud computing environment, wherein:
the cloud-native credential is received in association with a request for an
identity token, associated with the function, that comprises a cloud-agnostic credential;
determine, by the gateway, to instantiate a token platform instance based at least in part on validating the cloud-native credential;
instantiate, by the gateway, the token platform instance, wherein the token platform instance comprises a temporary computer-executable element configured to:
generate the identity token;
cause a token signing service to sign the identity token with a digital signature;
receive, from the token signing service, public key material associated with the digital signature; and
store the public key material in a public key repository;
receive, by the gateway, the identity token from the token platform instance; and
provide, by the gateway, the identity token to the function or a credential manager associated with the function.

13. The one or more non-transitory computer-readable media of claim 12, wherein the computer-executable instructions further cause the gateway to determine to instantiate the token platform instance based on at least one of:
determining that the request is in a valid format, or
determining that a number of requests for the identity token, over a period of time, is less than a threshold number.

14. The one or more non-transitory computer-readable media of claim 12, wherein:
the function or the credential manager is configured to provide the identity token to a second function that executes in a second cloud computing environment, and
the second function is configured to verify the identity of the function by:
retrieving the public key material from the public key repository, and
using the public key material to verify the digital signature of the identity token.

15. The one or more non-transitory computer-readable media of claim 14, wherein:
the second function is configured to provide an access credential to the function or the credential manager in response to verifying the identity of the function based on the identity token, and
the access credential is configured to permit interactions between the function and a third function.

16. The one or more non-transitory computer-readable media of claim 12, wherein the computer-executable instructions cause the gateway to:
store, at a first time, the identity token in a token cache of the gateway;
receive, at a second time, the cloud-native credential in association with a second request for the identity token;
return the identity token from the token cache in response to the second request; and
avoid re-instantiating the token platform instance in response to the second request.

17. A computing system, comprising:
one or more processors, and
memory storing computer-executable instructions associated with a gateway of an identity access management system that, when executed by the one or more processors, cause the gateway to:
receive a cloud-native credential that indicates an identity of a function executing within a cloud computing environment, wherein:
the cloud-native credential is received in association with a request for an identity token, associated with the function, that comprises a cloud-agnostic credential;
determine to instantiate a token platform instance based at least in part on validating the cloud-native credential;
instantiate the token platform instance, wherein the token platform instance comprises a temporary computer-executable element configured to:
generate the identity token;
cause a token signing service to sign the identity token with a digital signature;
receive, from the token signing service, public key material associated with the digital signature; and
store the public key material in a public key repository;
receive the identity token from the token platform instance; and
provide the identity token to the function or a credential manager associated with the function.

18. The computing system of claim 17, wherein:
the function or the credential manager is configured to provide the identity token to a second function that executes in a second cloud computing environment, and
the second function is configured to verify the identity of the function by:
retrieving the public key material from the public key repository, and
using the public key material to verify the digital signature of the identity token.

19. The computing system of claim 18, wherein:
the second function is configured to provide an access credential to the function or the credential manager in response to verifying the identity of the function based on the identity token, and
the access credential is configured to permit interactions between the function and a third function.

20. The computing system of claim 17, wherein the computer-executable instructions cause the gateway to:
store, at a first time, the identity token in a token cache of the gateway;
receive, at a second time, the cloud-native credential in association with a second request for the identity token;
return the identity token from the token cache in response to the second request; and
avoid re-instantiating the token platform instance in response to the second request.
